(19) United States
(12) Patent Application Publication
(10) Pub. No.: US 2009/0040047 A1
(43) Pub. Date: Feb. 12, 2009

(54) RFID System and Method of Communication Therein

(75) Inventor: Joshua Posamentier, Oakland, CA (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/836,404

(22) Filed: Aug. 9, 2007

(51) Int. Cl. G08B 13/14

(52) U.S. Cl. 340/572.1

(57) ABSTRACT

Disclosed is an RFID system. The RFID system comprises a plurality of RFID tags and an RFID reader. The RFID reader communicates with the plurality of RFID tags. The RFID reader is capable of sending a signal, which represents a time gap required in successive responses of each RFID tag of the plurality of RFID tags to the RFID reader. Each RFID tag of the plurality of RFID tags is capable of maintaining the time gap in successive responses to the RFID reader.

### FIELD

The present disclosure relates to RFID systems and, more particularly, to a system and method for improving the performance of the RFID systems.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a block diagram illustrating an RFID system, according to an exemplary embodiment of the present disclosure;

FIG. 2 is a block diagram illustrating an RFID reader, according to an exemplary embodiment of the present disclosure; and

FIG. 3 is a block diagram illustrating an RFID tag, according to an exemplary embodiment of the present disclosure.

Like reference numerals refer to like parts throughout the description of several views of the drawings.

### DETAILED DESCRIPTION OF THE DISCLOSURE

For a thorough understanding of the present disclosure, refer to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

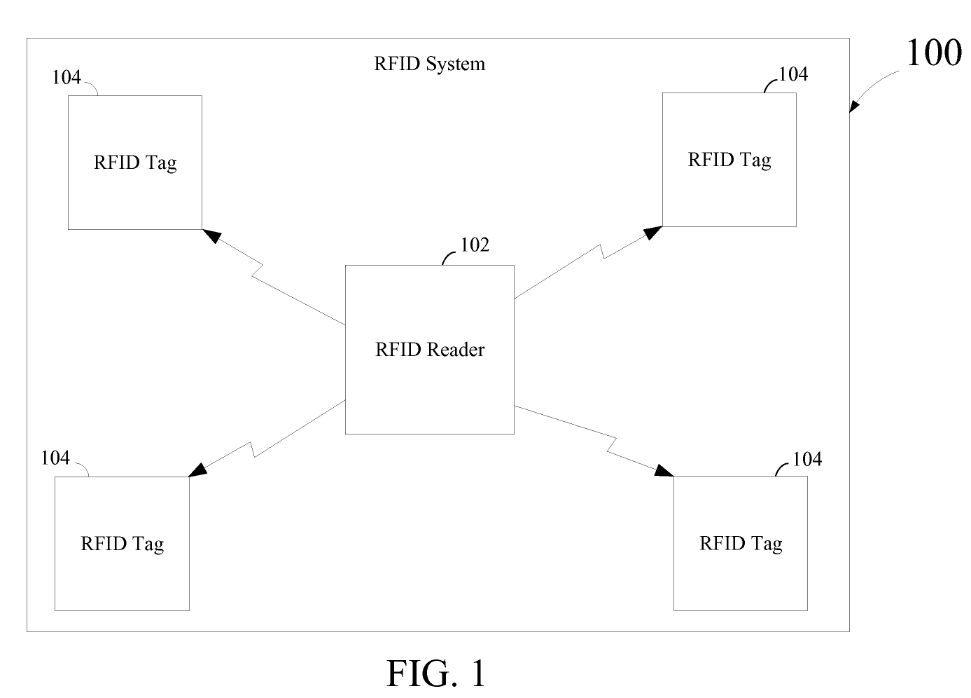

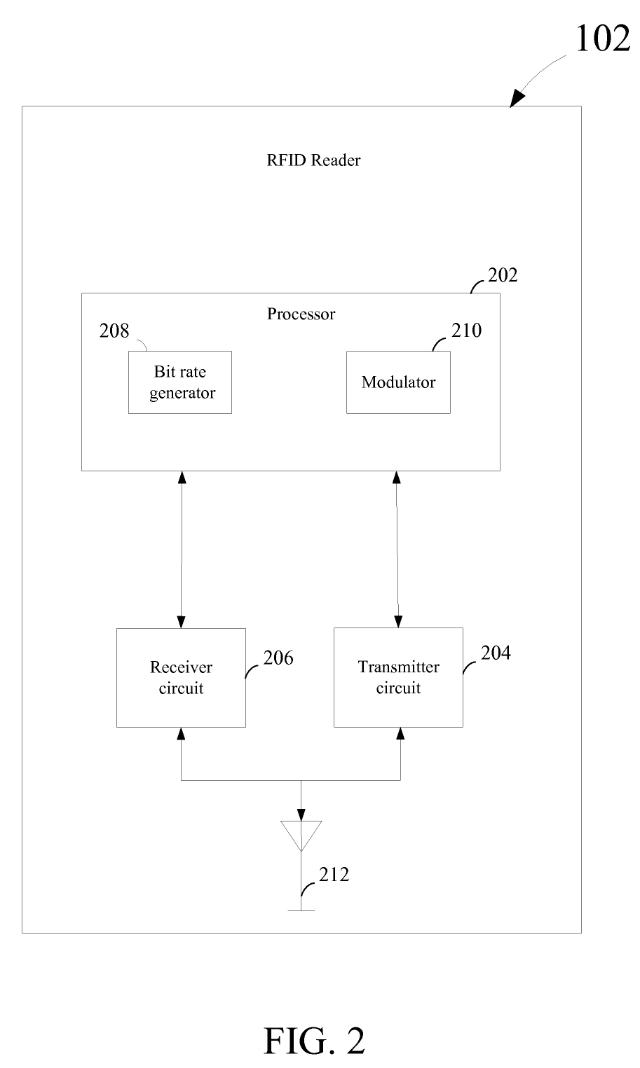

FIG. 1 is a block diagram illustrating an RFID system 100 consistent with the present disclosure. The RFID system 100 may include an RFID reader 102 and a plurality of RFID tags 104. The RFID reader 102 (hereinafter referred to as ‘reader 102’) may be configured to communicate with the plurality of RFID tags 104 (hereinafter referred to as ‘tags 104’), that are present in the field of view (FOV) of the reader 102. Field of view is defined as the area and volume of space which is covered by an antenna or inductively coupling coil. Each tag of the tags 104 may be uniquely identified with identification (ID). Generally, the reader 102 sends an unmodulated carrier signal and the tags 104 harvest powers from the unmodulated career signal. Upon powering up, the tags 104 provide the reader 102 with their corresponding IDs. The functioning and the architecture of the reader 102 are described further in conjunction with FIG. 2.

FIG. 2 is a block diagram illustrating the reader 102. The reader 102 comprises a processor 202, a transmitter circuit 204 and a receiver circuit 206. The processor 202 is configured to generate a signal representative of a time gap required in successive responses of the tags 104 to the reader 102. The processor 202 comprises a bit rate generator 208 and a modulator 210. The bit rate generator 208 is configured to generate a first signal. The first signal is generated based on the number of tags present in the FOV of the reader 102. For example, the number of tags present in the FOV of the reader 102, as represented in FIG. 1 is four.

In one embodiment of the present disclosure, the bit rate generator 208 comprises a finite state machine (not shown in FIG. 2). The finite state machine takes the number of tags in the FOV of the reader 102 as an input. Thereafter, the finite state machine selects a bit rate of a particular frequency based on the number of tags to generate the first signal. It will be apparent to a person skilled in the art that the bit rates of particular frequencies can be generated by multiplying or dividing a fixed frequency signal, as generated by a reference clock generator (not shown in FIG. 2). The modulator 210 is configured to modulate the first signal so as to generate the signal representative of time gap. The time gap corresponds to a duration that lies between two successive responses of a tag present in the FOV of the reader 102. In one embodiment of the present disclosure, the modulator 210 performs amplitude modulation (AM) to the first signal to generate the signal representative of the time gap. A person skilled in the art would appreciate that the modulator may also use other type of modulation schemes including, but not limited to, pulse-width modulation, pulse-coded modulation, frequency modulation and phase modulation.

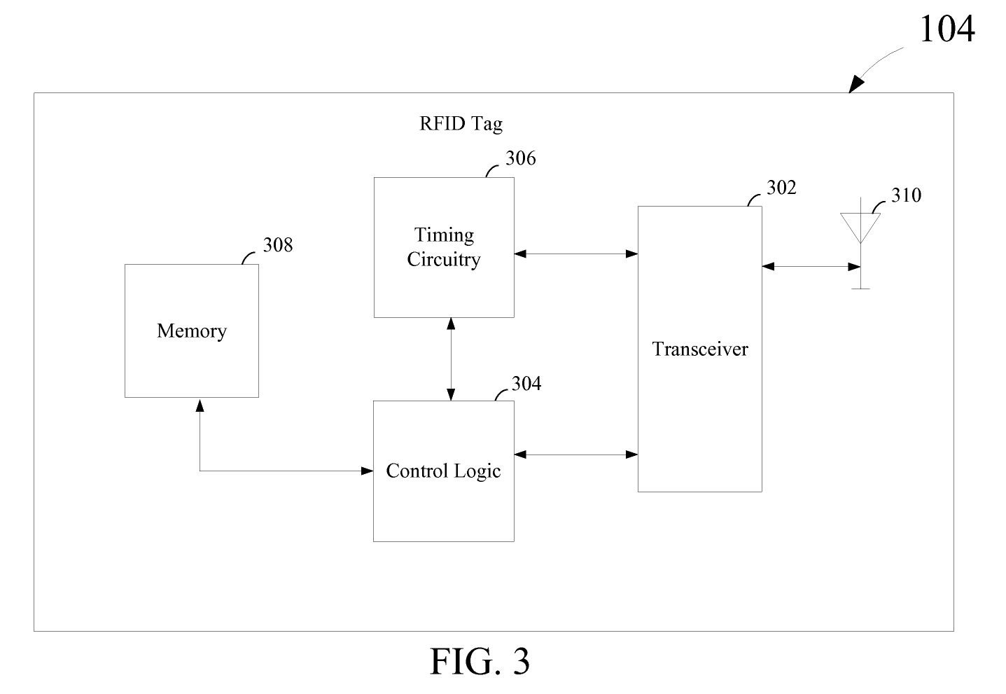

The transmitter circuit 204 transmits the signal representative of the time gap to the tags 104. The receiver circuit 206 is configured to receive the successive responses from each of the tags. In one embodiment of the present disclosure, the transmitter circuit 204 and the receiver circuit 206 use an antenna 212 to communicate with the tags 104. The functioning of the tags 104 is explained further in conjunction with FIG. 3.

FIG. 3 is a block diagram illustrating a tag of the tags 104 (hereinafter referred to as ‘tag 104’). The tag 104 comprises a transceiver 302, a control logic 304, a timing circuitry 306 and a memory 308. The tag 104 is chosen for the purposes of description only. The transceiver 302 comprises a transmitter and a receiver (not shown separately). The transceiver 302 communicates with the reader 102 via an antenna 310. Using the antenna 310, the transceiver 302 receives the signal representative of the time gap from the reader 102. The receiver of the transceiver 302 may be an AM detector, or a similar detector. Further, the transceiver 302 sends the ID of the RFID tag 104 to the reader 102.

The control logic 304 fetches the signal representative of the time gap as input from the transceiver 302. The control logic 304 generates a control signal in response to the signal representative of the time gap. The control signal is fed to the timing circuitry 306. The timing circuitry 306 broadcasts a pulse containing information about the ID of the RFID tag 104 in a periodic manner to the reader 102. The duty cycle of the pulse may be varied based on the control signal. In other words, the time gap between the successive responses of the RFID tag 104 to the reader 102 may be varied based on the control signal, which in turn, depends upon the signal representative of the time gap. The timing circuit 306 takes the ID of the RFID tag 104 from the memory 308, which stores the ID of the RFID tag 104. The memory 308 may also include other information including, but not limited to, price of a commodity onto which the tag is attached, the security codes related to the commodity, type and nature of the commodity and the placement of the commodity.

The communication between the reader 102 and the tags 104 in the RFID system 100 may also be explained by the following method. The method of communication in the RFID system comprises generating a signal representative of a time gap required in the successive responses of each tag (of the plurality of tags) to the RFID readers. The signal representative of the time gap is generated at the RFID reader. This signal is generated based on the number of tags that are present in the FOV of the RFID reader. For example, with reference to FIGS. 1-3, the method of communication includes generating the signal representative of the time gap at the reader 102. Thereafter, the reader 102 sends the signal representative of the time gap to each of the tags 104 present in the FOV of the reader 102. Again, the method comprises receiving the signal representative of the time gap at each tag of the tags 104. Further, the method includes maintaining the time gap in successive responses of the each of the tags 104 to the reader 102.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated. It is understood that various omissions and substitutions of equivalents are contemplated as circumstance may suggest or render expedient, but such omissions and substitutions are intended to cover the application or implementation without departing from the spirit or scope of the claims of the present disclosure.

What is claimed is:

1. An RFID system comprising:
a plurality of RFID tags; and
an RFID reader configured to communicate with the plurality of RFID tags and capable of sending a signal representative of a time gap required in successive responses from each tag of the plurality of RFID tags to the RFID reader;
wherein the each RFID tag of the plurality of RFID tags maintains the time gap in successive responses to the RFID reader based on the signal representative of the time gap.

2. The RFID system of claim 1, wherein the plurality of RFID tags are present in field of view of the RFID reader.

3. The RFID system of claim 1, wherein the signal representative of the time gap depends upon number of RFID tags in the plurality of RFID tags.

4. The RFID system of claim 1, wherein the RFID reader comprises:
a processor configured to generate the signal representative of the time gap;
a transmitter circuit configured to send the signal representative of the time gap to the each RFID tag of the plurality of RFID tags; and
a receiver circuit configured to receive the successive responses from the each RFID tag of the plurality of RFID tags.

5. The RFID system of claim 4, wherein the processor comprises:
a bit rate generator configured to generate a first signal in response to the number of RFID tags in the plurality of RFID tags; and
a modulator capable of modulating the first signal to generate the signal representative of the time gap.

6. The RFID system of claim 5, wherein the signal representative of the time gap is amplitude modulated signal.

7. The RFID system of claim 1, wherein the each RFID tag comprises:
a transceiver for communicating with the RFID reader, the transceiver configured to receive the signal representative of the time gap and to send corresponding ID of the each RFID tag to the RFID reader;
a control logic for generating a control signal in response of the signal representative of the time gap; and
a timing circuitry for maintaining the time gap in the successive responses to the RFID reader based on the control signal.

8. The RFID system of claim 7, wherein the each RFID tag further comprises a memory for storing the corresponding ID.

9. An RFID reader capable of communicating with a plurality of RFID tags, the RFID reader comprising:
a processor configured to generate a signal representative of a time gap required in successive responses of each RFID tag of the plurality of RFID tags to the RFID reader;
a transmitter circuit configured to send the signal representative of the time gap to the each RFID tag of the plurality of RFID tags; and
a receiver circuit configured to receive the successive responses from the each RFID tag of the plurality of RFID tags.

10. The RFID reader of claim 9, wherein the plurality of RFID tags are present in the field of view of the RFID reader.

11. The RFID reader of claim 9, wherein the processor comprises:
a bit rate generator configured to generate a first signal in response to the number of RFID tags in the plurality of RFID tags; and
a modulator capable of modulating the first signal to generate the signal representative of the time gap.

12. The RFID reader of claim 11, wherein the modulator performs an amplitude modulation to generate the signal representative of the time gap.

13. A method of communication in an RFID system, the RFID system comprising an RFID reader and a plurality of RFID tags, the method comprising:
generating a signal representative of a time gap required in successive responses of each RFID tag of the plurality of RFID tags to the RFID reader, at the RFID reader;
sending the signal representative of the time gap to the each RFID tag of the plurality of RFID tags, at the RFID reader;
receiving the signal representative of the time gap, at the each RFID tag of the plurality of RFID tags; and
maintaining the time gap in the successive responses of the each RFID tag based on the signal representative of the time gap, at the each RFID tag.

14. The method of communication of claim 13, wherein the plurality of RFID tags are present in the field of view of the RFID reader.

15. The method of communication of claim 13, wherein the signal representative of the time gap is generated based on number of RFID tags in the plurality of RFID tags.

16. The method of communication of claim 15, wherein the signal representative of the time gap is amplitude modulated signal.
